(19) United States
(12) Patent Application Publication
(10) Pub. No.: US 2013/0258217 A1
(43) Pub. Date: Oct. 3, 2013

(54) STEREOSCOPIC IMAGE DISPLAY DEVICE

(71) Applicants: Hiroshi AZUMA, Saitama-ken (JP); Takashi SASABAYASHI, Saitama-ken (JP)

(72) Inventors: Hiroshi AZUMA, Saitama-ken (JP); Takashi SASABAYASHI, Saitama-ken (JP)

(73) Assignee: Japan Display Central Inc., Fukaya-shi (JP)

(21) Appl. No.: 13/606,652

(22) Filed: Sep. 7, 2012

(30) Foreign Application Priority Data
Mar. 29, 2012 (JP) 2012-076947

(51) Int. Cl. G02F 1/1335

(52) U.S. Cl. 349/15

(57) ABSTRACT

In one embodiment, a stereoscopic image display device includes a display panel having a first display area for performing a two-dimensional display mode or a three-dimensional display mode selectively and a second display area performing a display mode different from the selected display mode in the first display area. A liquid crystal lens unit having first and second substrates and liquid crystal layer therebetween is arranged in front of the display panel for forming a liquid crystal lens corresponding to the three-dimensional display. The relation of a distance and a potential difference between counter electrodes arranged on the second substrate adjacent each other sandwiching a boundary display area between the first display area and the second display area is set so that generation of a different lens from a lens form to perform the three-dimensional display mode in either one of the first and second display areas is suppressed.

### CROSS-REFERENCE TO RELATED APPLICATION

This application is based upon and claims the benefit of priority from prior Japanese Patent Application No. 2012-076947, filed Mar. 29, 2012, the entire contents of which are incorporated herein by reference.

### FIELD

Embodiments described herein relate generally to a stereoscopic image display device including an area in which a two-dimensional display mode and a three-dimensional display mode are switchable.

### BACKGROUND

In recent years, in flat displays such as a liquid crystal display device, a stereoscopic image display device using stereoscopic images is known. One of the stereoscopic image display devices uses a gradient index lenses such as a liquid crystal lens arranged in front of a display panel. By controlling alignment of liquid crystal molecules of a liquid crystal layer by impressing voltage, the liquid crystal lens functions so as to give a distribution of the refractive index in the liquid crystal layer, and to make operate as the lens. The stereoscopic image display device is realized with the liquid crystal lens by making a right eye image displayed on the display panel enter in a viewer's right eye, and making a left eye image enter in the viewer's left eye. Moreover, it is also possible to switchover between the two-dimensional display mode and the three-dimensional display mode by switching ON and OFF the impressed voltage to the liquid crystal lens.

Furthermore, in the case of the liquid crystal lens, it is also possible to operate a portion of the liquid crystal lens unit as a lens corresponding to a portion of the display device. Therefore, according to this structure, a partial three-dimensional display is possible in which the three-dimensional display is made in an area of the display device while making the two-dimensional display in other areas.

In order to enable the partial three-dimensional display, it is necessary to form an alignment control electrode for carrying out alignment control of the liquid crystal molecules in an area of the liquid crystal lens, and to enable driving of the alignment control electrode formed in the area independently from other electrodes. Therefore, it is thought to provide a counter electrode facing the alignment control electrode through the liquid crystal layer every the alignment control electrode. However, in the above structure, there is a possibility that electric field generated between the adjoining alignment control electrodes and between the adjoining counter electrodes may give unnecessary influence to the alignment of the liquid crystal layer in a boundary area between the partial three-dimensional display area and the other display areas. If the alignment change of the liquid crystal molecules arises, there is a possibility that the distribution of the refractive index may change from desired distribution, and unnecessary image may be sighted in the boundary area.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is an elevation view of a stereoscopic image display device according to an embodiment.

FIGS. 2A and 2B are cross-sectional views of a two-dimensional/three-dimensional switchable display area taken along line 1-1 shown in FIG. 1.

FIGS. 3A, 3B and 3C are figures showing an electrode arrangement of an array substrate 301 and a counter substrate 302 of a liquid crystal lens unit 300.

FIG. 4 is a figure showing lateral electric field when potential difference between adjoining counter electrodes 404A and 404B in a boundary area is large.

FIG. 5 is a figure showing a model used in a simulation for examination of conditions among the distances between an alignment control electrode 402A and an alignment control electrode 402B, between the counter electrode 404A and the counter electrode 404B, and potential difference between the alignment control electrode 402A and the alignment control electrode 402B and between the counter electrode 404A and the counter electrode 404B in which influence of the refractive index change can be accepted.

FIG. 6 is a figure showing a distribution of a refractive index change value between the adjoining counter electrodes 404A and 404B at the time of changing the distance “d” between the adjoining counter electrodes 404A and 404B.

FIG. 7 is a figure showing the distribution of the refractive index change value between the counter electrodes 404A and 404B at the time of changing potential difference ΔV between the counter electrodes 404A and 404B.

FIG. 8 is a table showing a measured result of the distribution of the refractive index change value between the counter electrodes 404A and 404B at the time of changing the distance “p” and the potential difference ΔV by expanding the measured range.

FIG. 9 is a figure showing a maximum refractive index change value based on the measured result shown in the table in FIG. 8.

### DETAILED DESCRIPTION

A stereoscopic image display device according to an exemplary embodiment of the present invention will now be described with reference to the accompanying drawings wherein the same or like reference numerals designate the same or corresponding parts throughout the several views.

According to one embodiment, a stereoscopic image display device includes: a display panel including a first display area for performing a two-dimensional display mode or a three-dimensional display mode selectively and a second display area performing a display mode different from the selected display mode in the first display area, and a liquid crystal lens unit arranged in front of the display panel for forming a liquid crystal lens corresponding to the three-dimensional display mode, wherein the liquid crystal lens unit includes a liquid crystal layer arranged between a first substrate and a second substrate facing the first substrate, distribution of refractive index of the liquid crystal layer being changed by impressing a driving voltage, the first substrate includes a plurality of first electrodes formed corresponding to the first and second display areas for controlling an alignment of the liquid crystal layer, the second substrate includes a second electrode formed so as to face the first electrode through the liquid crystal layer, and the relation of a distance and a potential difference between the second electrodes arranged adjacent each other sandwiching a boundary display area between the first display area and the second display area is set so that generation of a different lens from a lens form to perform the three-dimensional display mode in either one of the first and second display areas is suppressed.

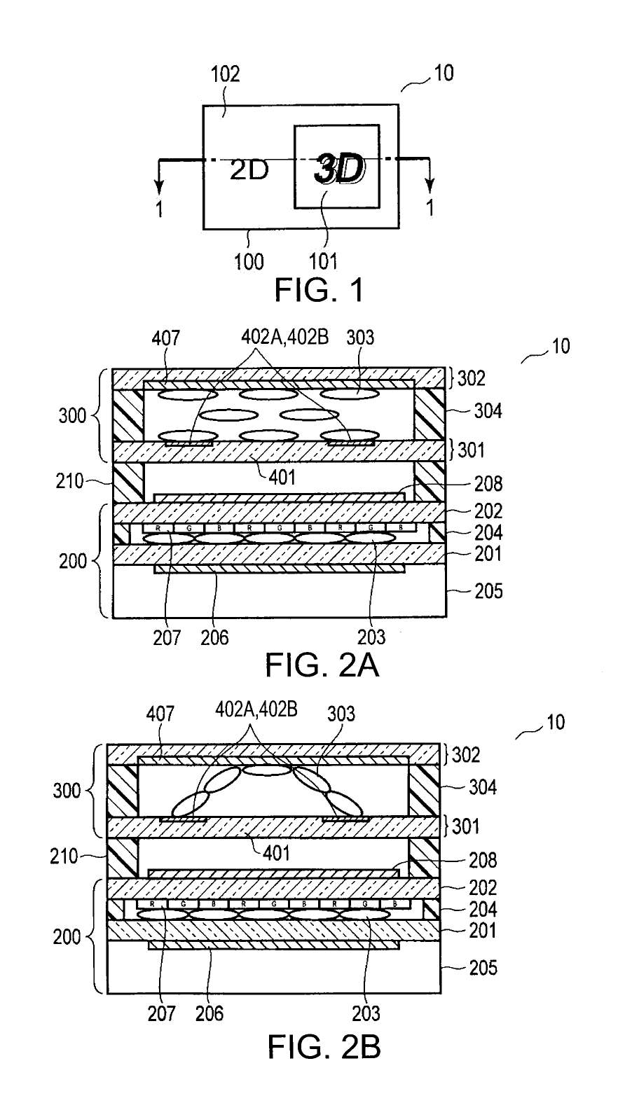

FIG. 1 is an elevation view of the stereoscopic image display device according to an embodiment. The stereoscopic image display device 10 shown in FIG. 1 includes a display area 100 in which images are displayed. According to this embodiment, the display device 10 is a stereoscopic image display device in which the partial three-dimensional display is possible.

As shown in FIG. 1, the display area 100 includes, a two dimensional/three-dimensional display switchable area 101 (hereafter referred as a selection display area), and a two dimensional/three-dimensional display non-switchable area 102 (hereafter referred as a fixed display area), respectively.

The selection display area 101 is an area provided in an intermediate inside position rather than a perimeter part of the display area 100, in which the two-dimensional display mode and the three-dimensional display mode are switchable. In this embodiment, it is possible to arrange the selection display area 101 apart from ends of the display area 100. Of course, the selection display area 101 may contact with the end of the display area 100. Moreover, in FIG. 1, although one selection display area 101 is provided in the display area 100, two or more selection display areas 101 may be formed. Furthermore, one selection display area 101 may be divided into two or more areas.

The fixed display area 102 is formed so as to surround the selection display area 101 of the display area 100, and is a display area in which the two-dimensional display mode and the three-dimensional display mode cannot be switched. In FIG. 1, the fixed display area 102 is made into the area in which the two-dimensional display is possible. Also the fixed display area 102 may be the area in which the three-dimensional display is possible.

FIGS. 2A and 2B are cross-sectional views showing the structure of the selection display area 101 taken along line 1-1 of the display device shown in FIG. 1 according to this embodiment. Here, FIG. 2A shows a state where voltage is not impressed to a liquid crystal layer 303 in the liquid crystal lens unit 300, and FIG. 2B shows a state where voltage is impressed to the liquid crystal layer 303 in the liquid crystal lens unit 300.

As shown in FIGS. 2A and 2B, the stereoscopic image display device 10 includes a display panel 200 and the liquid crystal lens unit 300. The display panel 200 and the liquid crystal lens unit 300 are stuck so as to have a predetermined gap therebetween by a spacer 210. Air layer is provided between the display panel 200 and the liquid crystal lens unit 300, for example.

However, in FIGS. 2A and 2B, the explanation is made as if only the selection display area 101 is constructed by the discreet display panel 200 and the discrete liquid crystal lens unit 300 in order to explain simply. However, practically, the display panel 200 and the liquid crystal lens unit 300 are formed in a whole display area 100 including the fixed display area 102. That is, a portion thereof is shown as an example, and following explanation is also the same.

The display panel 200 displays images. FIG. 2A and FIG. 2B show an example which uses a liquid crystal display panel as the display panel 200. However, the display panel 200 is not limited to the liquid crystal display panel, and also an organic electroluminescence display panel or a plasma display panel may be used.

The display panel 200 is constituted by holding a liquid crystal layer 203 between an array substrate 201 and a counter substrate 202. The array substrate 201 and the counter substrate 202 are sealed with a sealing agent 204 in the circumference thereof. Further, they are stuck so as to have a predetermined gap therebetween by a spacer in the shape of a ball or a pillar (not shown). Moreover, a backlight 205 is arranged in the back of the array substrate 201.

In the array substrate 201, pixel electrodes constituting pixels are formed in the shape of a matrix. A thin film transistor (TFT) is connected to each pixel electrode. When a corresponding TFT is switched ON, voltage is impressed to the liquid crystal layer 203 through the pixel electrode. Moreover, a polarizing plate 206 is formed on a light incident side of the array substrate 201.

A color filter 207 of red (R), green (G), and blue (B) is formed on the counter substrate 202 corresponding to each pixel, and further, a counter electrode is formed on the color filter 207. Moreover, a polarizing plate 208 is formed on the light emitting side of the counter substrate 202. The color filter 207 may be also formed on the array substrate 201 side.

In the liquid crystal display panel 200, the display is made by controlling electric field generated in the liquid crystal layer 203 which is held between the pixel electrode and the counter electrode by controlling the magnitude of the voltage impressed to the pixel electrode. The liquid crystal layer has characteristic that alignment of the liquid crystal molecule changes by impressing electric field, and the transmissivity of the light which passes the liquid crystal layer 203 changes by the alignment of the liquid crystal molecule. A display in each pixel unit is performed by controlling the penetration of the light per pixel (pixel electrode unit).

In the liquid crystal lens unit 300, the liquid crystal layer 303 is held between the array substrate 301 and the counter substrate 302. The array substrate 301 and the counter substrate 302 are stuck by a spherical or pillar shaped spacer (not shown) so as to have a predetermined gap therebetween, while the circumference is sealed with the sealing agent 304. According to this embodiment, bead-like spacers are used by scattering in place of the pillar shaped spacer in consideration of workability.

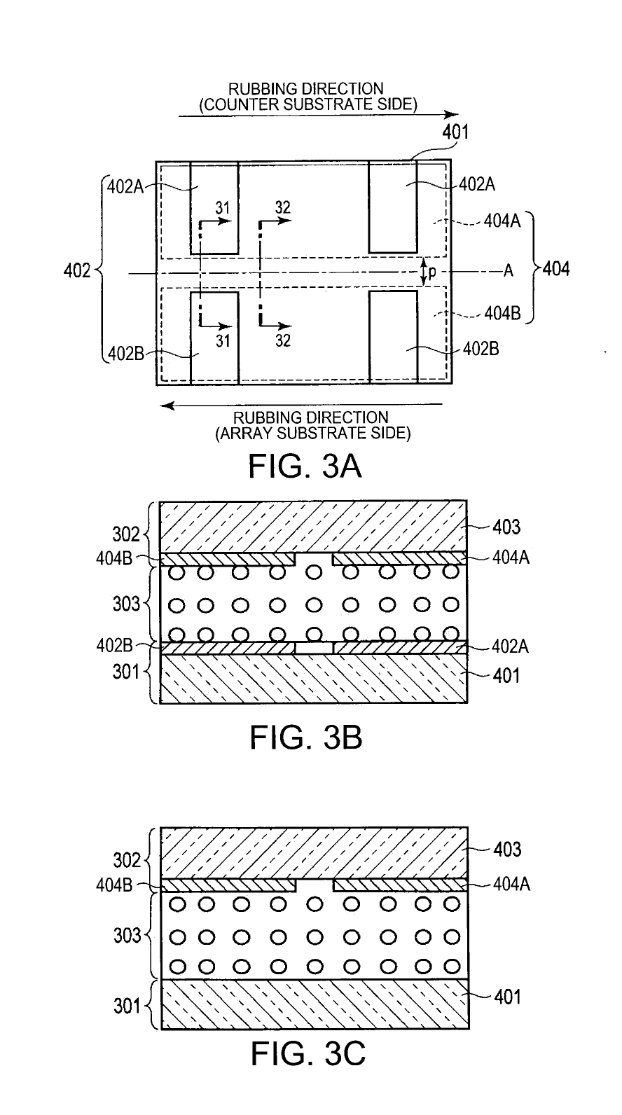

Hereafter, the liquid crystal lens unit 300 is explained with reference to FIGS. 2A, 2B and FIGS. 3A, 3B, 3C. FIGS. 3A, 3B, 3C are figures showing electrode structures of the array substrate 301 and the counter substrate 302 of the liquid crystal lens unit 300, respectively. FIG. 3A shows a plan view of the array substrate 301, FIG. 3B shows a cross-sectional view taken along line 31-31 including the counter substrate 302 in FIG. 3A, and FIG. 3C shows a cross-sectional view taken along line 32-32 including the counter substrate 302 shown in FIG. 3A.

An alignment film (not shown) is formed on the surface of the array substrate 301. Here, the direction of rubbing processing of the alignment film is a direction orthogonally crossing the control electrode 402, as shown in FIG. 3A.

Alignment control electrodes 402A and 402B as a first electrode are formed on the glass substrate 401 which constitutes the array substrate 301. The alignment control electrodes 402A and 402B are transparent electrodes, such as ITO (Indium Tin Oxide), and are connected to a driving power supply source of the liquid crystal lens unit 300 which is not illustrated. At least a pair (two) of the alignment control electrodes 402A and 402B is formed in one selection display area 101. The liquid crystal lens unit 300 shown in FIG. 3A includes a boundary display area between the selection display area 101 arranged in an upper portion and a fixed selection area 102 arranged in a lower portion sandwiching a chain line therebetween in the figure. The respective alignment control electrodes 402A and 402B are provided in the selection area 101 and the fixed area 102, respectively. In order to drive independently the respective display areas 101 and 102, at least two pairs (four) of alignment control electrodes 402A and 402B are required.

Counter electrodes 404A and 404B as a second electrode are formed on the glass substrate 403 in the counter substrate 302. The counter electrodes 404A and 404B are formed of a transparent electrode, such as ITO (Indium Tin Oxide), and are connected to a driving power supply source of the liquid crystal lens unit 300 which is not illustrated. Here, the liquid crystal lens unit 300 in FIG. 3 shows one example in which one counter electrode 404A and one counter electrode 404B are formed, respectively, in the divided selection display area 101 and the fixed display area 102. Moreover, an alignment film (not shown) is formed on the surface of the counter electrodes 404A and 404B on the counter substrate 302. Here, the rubbing treatment direction of the alignment film is an opposite direction to the rubbing direction of the array substrate 301.

Since, in the above liquid crystal lens unit 300, the alignment control electrode 402A and the counter electrode 404A of the selection display area 101, and the alignment control electrode 402B and the counter electrode 404B of the fixed display area 102 are formed independently in the respective display areas 101 and 102. Therefore, it becomes possible to drive the respective display areas 101 and 102 in the liquid crystal lens unit 300, independently. Accordingly, it is possible to switch the two-dimensional display mode and the three-dimensional display mode by controlling the magnitude of the driving voltages supplied to the alignment control electrode 402A and the counter electrode 404A in the selection display area 101, and setting the timing of the voltages in synchronization to the image signals supplied to the display panel 200.

For example, in case a driving voltage is impressed to the selection display area 101 so that the potential of the alignment control electrode 402A and the counter electrode 404A becomes equal, electric field does not occur in the liquid crystal layer 303. Therefore, as shown in FIG. 2A, the liquid crystal molecule in the liquid crystal layer 303 is aligned so that the liquid crystal molecule is regulated in the rubbing direction in the selection display area 101. In this case, the refractive index of the liquid crystal layer 303 becomes uniform, and the image light from the display panel 200 goes straight in the inside of the liquid crystal layer 303. In this case, the two-dimensional display is performed. As a result, when the two-dimensional display is performed in the fixed display area 102, the two-dimensional image display is performed over the whole display area 100, like the usual two-dimensional display.

On the other hand, if the driving voltage is impressed to the selection display area 101 so that potential difference is given only between the alignment control electrode 402 A and the counter electrode 404A, electric field occurs between the alignment control electrode 402A and the counter electrode 404A. For example, if the potential of the alignment control electrode 402A is made into higher rather than counter electrode 404A in the selection display area 101, the liquid crystal molecule of the liquid crystal layer 303 is aligned by electric field generated between the alignment control electrode 402A and the counter electrode 404A as shown in FIG. 2B, and the refractive index of the liquid crystal layer 303 between the alignment control electrode 402A and the counter electrode 404A becomes small. For this reason, the refractive-index distribution of the liquid crystal layer 303 between the alignment control electrodes 402A changes, and the liquid crystal layer 303 functions as a lens. Therefore, a partial three-dimensional display is performed in the selection display area 101 by displaying the image which has azimuth difference on the area of the display panel 200 corresponding to the selection display area 101, and making the respective images having azimuth difference enter in the different eyes of the viewer through the liquid crystal lens unit 300. In this case, if the fixed display area is constituted so that the three-dimensional display is also performed in the fixed display area 102, it becomes possible to perform the three-dimensional display over the whole display area 100. In addition, in this case, if the selection display area 101 is set so that the two-dimensional display is performed, the partial two-dimensional display may be possible.

In the liquid crystal lens unit 300 shown in FIG. 3A, the pair of the alignment control electrode 402A and the counter electrode 404A, and the pair of the alignment control electrode 402 B and the counter electrode 404B are formed on both sides sandwiching the chain line A, respectively. Therefore, according to above structure, it is possible to switchover independently between the two-dimensional display mode and the three-dimensional display mode in the upper area and the lower area defined by the chain line A in the liquid crystal lens unit 300, respectively.

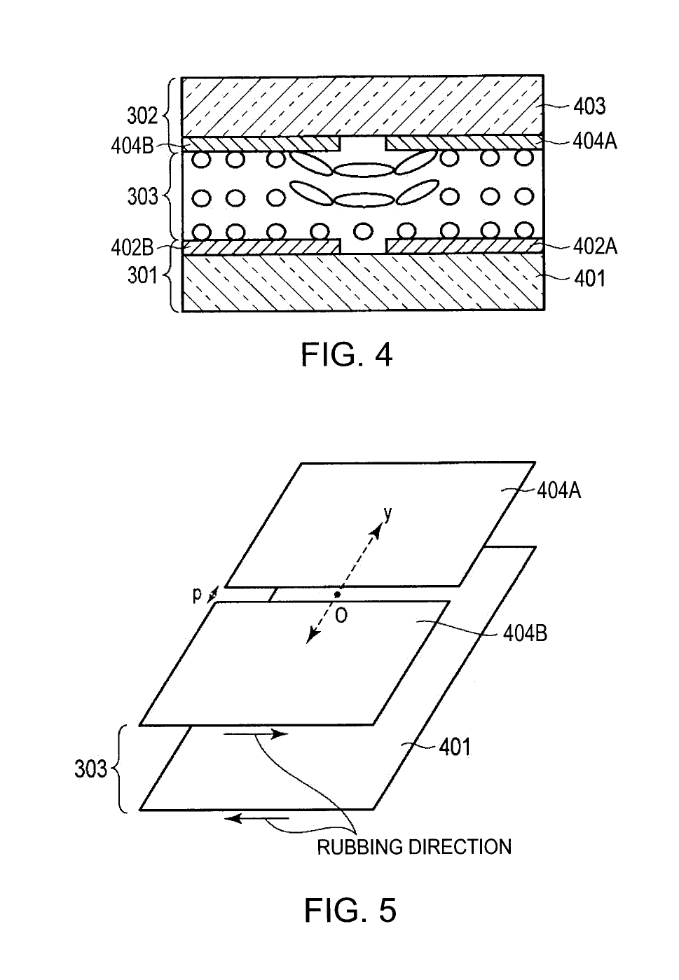

When performing the two-dimensional display in the display area on the upper side of the chain line A and performing the three-dimensional display in the area on the lower side of the chain line A in the figure, there is a possibility that unnecessary electric field is generated between the alignment control electrodes 402A and 402B, and between the counter electrodes 404A and 404B in a boundary display area between the selection display area 101 and the fixed display area 102, depending on the driving method of each display area. In the above case, the unnecessary potential difference arises when different display modes, i.e., the two-dimensional display mode and the three-dimensional display mode are performed in the respective display areas 101 and 102 each other. In particular, when performing the image display of the same display mode over the whole display area 100, it is not necessary to take into consideration. For example, if the potential difference is generated between the counter electrode 404A formed in the upper area and the counter electrode 404B formed in the lower area sandwiching the chain line A, the electric field (lateral electric field) between the counter electrodes 404A and 404B is also formed. If the lateral electric field occurs, the alignment of the liquid crystal molecule of the shape of a lens arises as shown in FIG. 4, and the alignment gives influence to the distribution of the refractive index of the liquid crystal layer 303. As a result, a portion of the image displayed in the display panel 200 arranged on the lower side of the lens unit 300 may be expanded in the boundary display area between the display areas 101 and 102 in the lens unit 300 by a lens effect through the gap between the alignment control electrodes 402A and 402B. Therefore, there is a possibility of causing deterioration of display grace.

By the way, it is generally known that electric field is proportional to the potential difference between electrodes, and that it is in inverse proportional to the distance between electrodes. Therefore, in order to control the lateral electric field as shown in FIG. 4, it is necessary to make the distances between the alignment control electrodes 402A and 402B, and between the counter electrodes 404A and 404B long, or to make small the potential differences between the alignment control electrodes 402A and 402B, and between the counter electrodes 404A and 404B.

However, when making the two-dimensional display and the three-dimensional display in mix, the potential difference between the three-dimensional display and the two-dimensional display in the boundary display area is necessarily generated. Therefore, the potential difference can not be made small simply. Moreover, when the distance (gap) in the boundary display area is simply enlarged, the non-displaying area (space portion) occupied in the boundary portion becomes large, and the non-displaying area is sighted in the shape of a frame. Accordingly, the fall of the display grace is resulted.

The inventors reviewed acceptable conditions against the refractive index changes with respect to the distances between the alignment control electrodes 402A and 402B and between the counter electrodes 404A and 404B, and the potential differences between the alignment control electrodes 402A and 402B and between counter electrode 404A and 404B.

FIG. 5 shows a model used in the simulation for reviewing the acceptable conditions against the refractive index changes with respect to the distances between the alignment control electrodes 402A and 402B and between the counter electrodes 404A and 404B, and the potential differences between the alignment control electrodes 402A and 402B and between counter electrode 404A, and 404B. In the model shown in FIG. 5, the distance and the potential difference between the counter electrode 404A and 404B are changed to control the lens-like alignment of the liquid crystal molecules. In this case, the potential difference between the alignment control electrodes 402A and 402B is presumed to be a fixed value. When the distance and the potential difference between the alignment control electrodes 402A and 402B are changed, same result was obtained as described hereinafter.

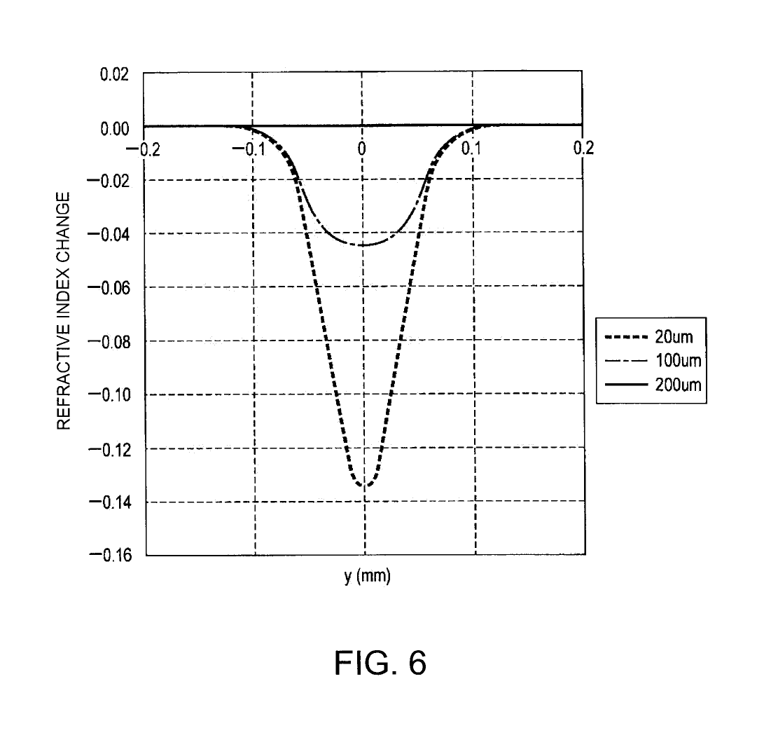

FIG. 6 is a figure showing a distribution of the refractive index change between the counter electrodes 404A and 404B in the boundary display area between the display areas 101 and 102 when a distance “p” between the adjoining counter electrodes 404A and 404B is changed. Herein, in FIG. 6, the half position of the distance “p” between the counter electrodes 404A and 404B is set to 0. FIG. 6 shows the distribution of the refractive index change value in the range of ±0.2 mm in a y direction in the figure with respect to the referential point 0. That is, the horizontal axis y in FIG. 6 shows amount of position change from the reference position 0, and the vertical axis of FIG. 6 shows the refractive index change value. Here, the refractive index change value in this simulation shows a difference between the measured refractive index and the refractive index in y=−0.2 mm (or y=+0.2 mm) in which the refractive index change becomes the maximum. Moreover, the potential difference ΔV between the adjoining counter electrodes 404A and 404B is set to a constant value of 3V. Furthermore, the distance “p” between the counter electrodes 404A and 404B is set to 20 μm, 100 μm, and 200 μm, and the simulation was performed.

As shown in FIG. 6, even if the distance “p” between counter electrodes 404A and 404B is set to any one of 20 μm, 100 μm, and 200 μm, the refractive index change value becomes the maximum at the reference position 0. Furthermore, the refractive index change value becomes smaller with increase in the distance “p”, and in case of 200 μm, a refractive index change value becomes nearly zero. Reviewing the FIG. 6, if the distance “p” between the counter electrodes 404A and 404B is set to be long, the refractive index change can be lessened with increase in the distance therebetween. Accordingly, it turns out that unnecessary alignment of the liquid crystal layer can be controlled.

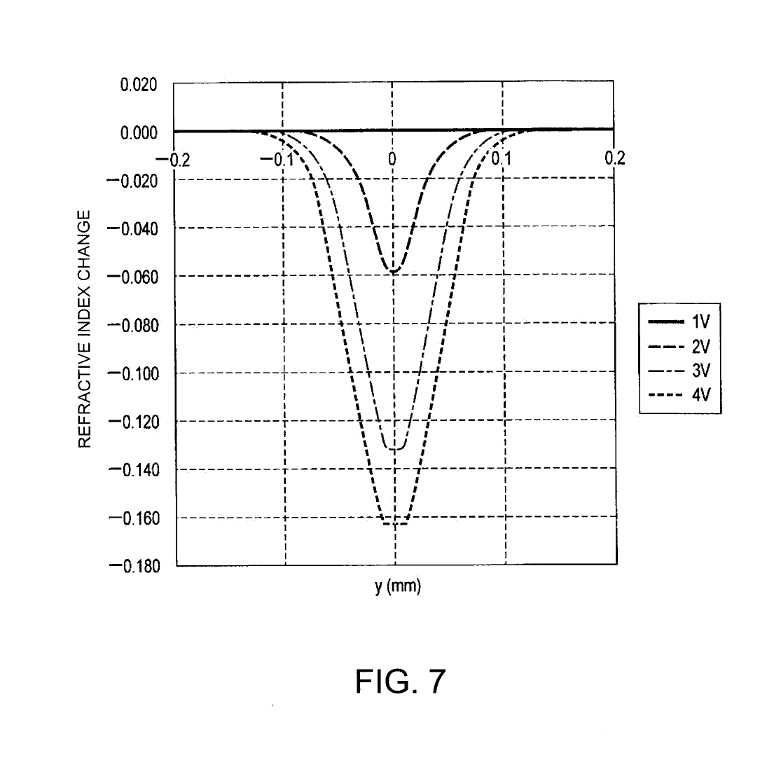

FIG. 7 is a figure showing a distribution of the refractive index change between the counter electrodes 404A and 404B when the potential difference ΔV between the counter electrodes 404A and 404B is changed. In FIG. 7, the half position of the distance “p” between the counter electrodes 404A and 404B is set to 0 like the FIG. 6. FIG. 7 shows the distribution of the refractive index change value in the range of ±0.2 mm in the y direction in the figure with respect to the reference position 0. Moreover, the distance between the adjoining counter electrodes 404A and 404B is set to a constant value of 20 μm. Furthermore, the potential difference ΔV between the counter electrodes 404A and 404B is set to 1V, 2V, 3V and 4V, and the simulation was performed.

As shown in FIG. 7, even if the potential difference ΔV between counter electrodes 404A and 404B is set to any one of 1V, 2V, and 3V, and 4V, the refractive index change value at the reference position 0 becomes the maximum. Furthermore, the refractive index change value becomes larger with increase in the potential difference ΔV, and in case of 1V, the refractive index change value becomes nearly 0. Reviewing the FIG. 7, if the potential difference ΔV between the counter electrodes 404A and 404B is set to be small, the refractive index change can be lessened with decrease in the potential difference ΔV. Accordingly, it turns out that unnecessary alignment of the liquid crystal layer can be controlled.

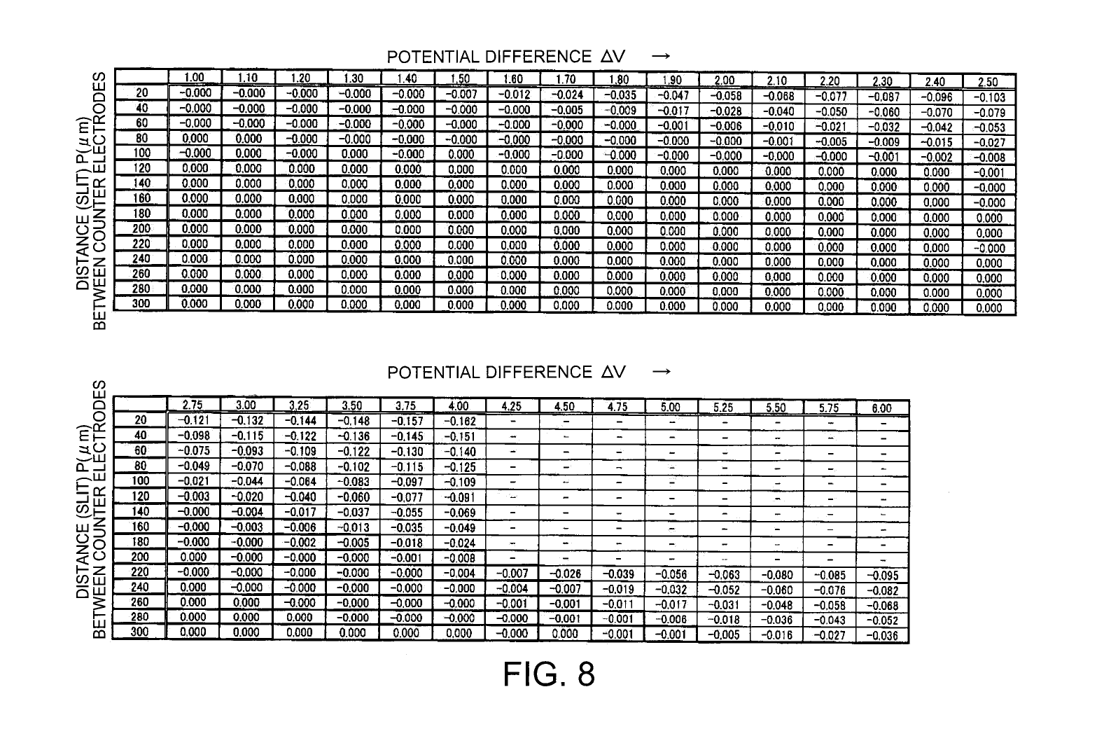

Then, the measurement was made by expanding the measured range of the distance “p” and the potential difference ΔV between the counter electrodes 404A and 404B in order to review in more detail. FIG. 8 is a table showing a result of the measurement.

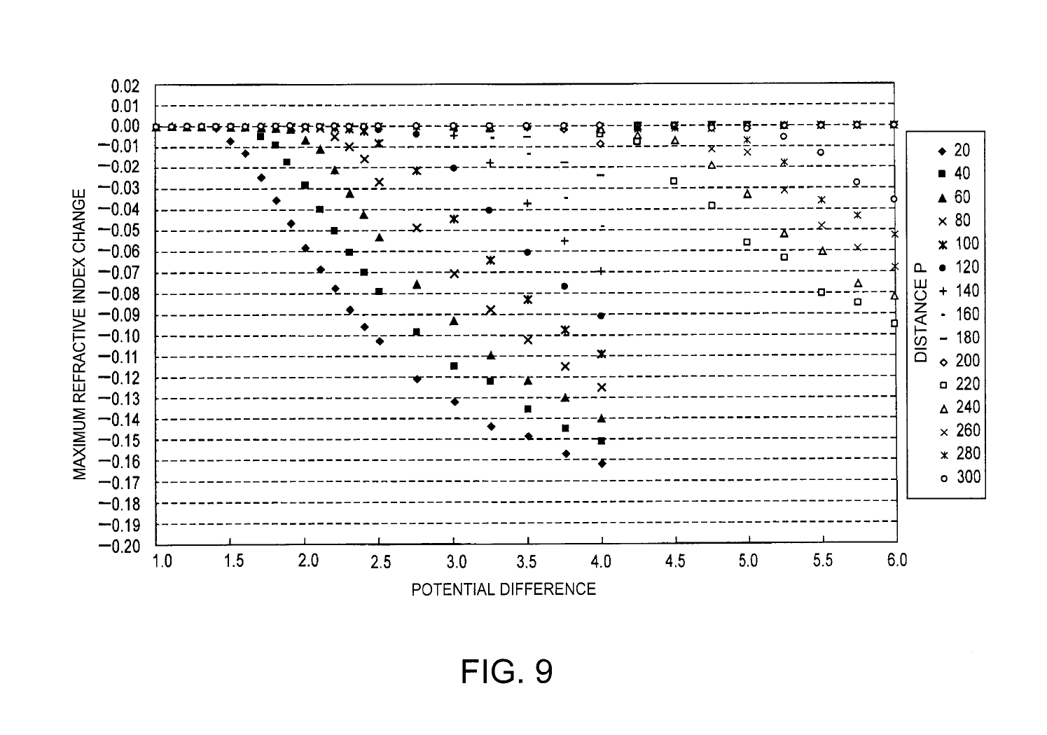

FIG. 9 is a figure showing a graph by making the result shown in the table 1 in FIG. 8 into a maximum refractive index change value. Here, the maximum refractive index change value shows the refractive index change value in y=0. As shown in FIG. 9, the maximum refractive index change value becomes small with increase in the distance “p” or with decrease in the potential difference ΔV. The maximum acceptable refractive index change value which is a threshold value for judging that the refractive index change value is acceptable or not, is set to −0.01 by viewing. If the distance “p” and the potential difference ΔV are set so that the refractive index change value becomes larger than −0.01, even if the different display mode is performed in the selection display area 101 and the fixed display area 102 each other, it turned out that influence to the display grace, such as generating of the unnecessary image in the boundary display area between the display area 101 and the display area 102, was hardly caused.

From the result of the table in FIG. 8 and the graph in FIG. 9, when the maximum acceptable refractive index change value is set to −0.01, the relation of the following Equation 1 was derived. If the relation of the distance “p” and the potential difference ΔV between the counter electrodes 404A and 404B is satisfied with an equation 1, the refractive index change between counter electrodes 404A and 404B does not give bad influence to the display grace even in case where some images are displayed in the selection display area 101 in a different display mode from that of the fixed display area 102.

ΔV≦0.0125×p+1.25+n (Equation 1)

Here, ΔV shows the acceptable potential difference, “p” shows the distance (μm) between the counter electrodes, 0.0125 and 1.25 show coefficients derived from the measured result shown in the table in FIG. 8, and “n” shows a corrected value (0 is included) for making the Equation 1 correspond to specification change, etc.

The Equation 1 is an example at the time of setting the maximum acceptable refractive index change value to −0.01 by visual evaluation. In this case, the corrected value “n” is set to 0. Even if the maximum acceptable refractive index change value is changed from −0.01, the relation between ΔV and “p” is approximated by the Equation 1.

As mentioned above, in the liquid crystal lens unit 300 according to the embodiments, since the alignment control electrodes 402A and 402B, and the counter electrodes 404A and 404B are located adjoining each other in the boundary display area between the selection display area 101 and the fixed display area 102 by setting the distance and the potential difference between the adjacent alignment control electrodes 402A and 402B, and between the adjacent counter electrodes 404A and 404B to suitable values, it is possible to control generating of electric field between the alignment control electrodes 402A and 402B, and between the counter electrodes 404A and 404B adjoining on both sides of the boundary area, and to suppress the unnecessary refractive index change in the boundary display area between the selection display area 101 and the fixed display area 102. Thereby, it is possible to form the liquid crystal lens with good characteristic.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic image display device, comprising,
a display panel including a first display area for performing a two-dimensional display mode or a three-dimensional display mode selectively and a second display area performing a display mode different from the selected display mode in the first display area, and
a liquid crystal lens unit arranged in front of the display panel for forming a liquid crystal lens corresponding to the three-dimensional display mode, wherein
the liquid crystal lens unit includes a liquid crystal layer arranged between a first substrate and a second substrate facing the first substrate, distribution of refractive index of the liquid crystal layer being changed by impressing a driving voltage,
the first substrate includes a plurality of first electrodes formed corresponding to the first and second display areas for controlling an alignment of the liquid crystal layer,
the second substrate includes a second electrode formed so as to face the first electrode through the liquid crystal layer, and
the relation of a distance and a potential difference between the second electrodes arranged adjacent each other sandwiching a boundary display area between the first display area and the second display area is set so that generation of a different lens from a lens form to perform the three-dimensional display mode in either one of the first and second display areas is suppressed.

2. The stereoscopic image display device according to claim 1, wherein the relation of the distance and the potential difference between the second electrodes arranged adjacent each other sandwiching the boundary display area between the first display area and the second display area is substantially set by a following equation.
ΔV≦0.0125×p+1.25+n
Wherein “p” (μm) shows the distance between the second electrodes, ΔV(V) shows the potential difference between the second electrodes, and “n” shows a correction value.

3. The stereoscopic image display device according to claim 1, wherein the different lens from the lens form to perform the three-dimensional display in either one of the first and second display areas is a concave lens.

4. A stereoscopic image display device, comprising,
a display panel including a first display area for performing a two-dimensional display mode or a three-dimensional display mode selectively and a second display area performing a display mode different from the selected display mode in the first display area, and
a liquid crystal lens unit arranged in front of the display panel for forming a liquid crystal lens corresponding to the three-dimensional display mode, wherein
the liquid crystal lens unit includes a liquid crystal layer arranged between a first substrate and a second substrate facing the first substrate, distribution of refractive index of the liquid crystal layer being changed by impressing a driving voltage,
the first substrate includes a plurality of first electrodes formed corresponding to the first and second display areas for controlling an alignment of the liquid crystal layer,
the second substrate includes a second electrode formed so as to face the first electrode through the liquid crystal layer, and
the relation of a distance and a potential difference between the first electrodes arranged adjacent each other sandwiching a boundary display area between the first display area and the second display area is set so that generation of a different lens from a lens form to perform the three-dimensional display mode in either one of the first and second display areas is suppressed.

5. The stereoscopic image display device according to claim 4, wherein the relation of the distance and the potential difference between the first electrodes arranged adjacent each other sandwiching a boundary display area between the first display area and the second display area is substantially set by a following equation.
ΔV≦0.0125×p+1.25+n
Wherein “p” (μm) shows the distance between the first electrodes, ΔV(V) shows the potential difference between the first electrodes, and “n” shows a correction value.

6. The stereoscopic image display device according to claim 4, wherein the different lens from the lens form to perform the three-dimensional display mode in either one of the first and second display areas is a concave lens.
